(19) United States
(12) Patent Application Publication
(10) Pub. No.: US 2008/0313158 A1
(43) Pub. Date: Dec. 18, 2008

(54) Database file management system, integration module and browsing interface of database file management system, database file management method

(76) Inventor: Tsu-Shun Lin, Taipei (TW)

Correspondence Address: MARTINE PENILLA & GENCARELLA, LLP, 710 LAKEWAY DRIVE, SUITE 200, SUNNYVALE, CA, 94085, US

(21) Appl. No.: 12/157,562

(22) Filed: Jun. 10, 2008

(30) Foreign Application Priority Data
Jun. 15, 2007 (TW) 96121695

(51) Int. Cl. G06F 7/06; G06F 17/30

(52) U.S. Cl. 707/3; 707/200; 707/100; 707/E17.005; 707/E17.044; 707/E17.014

(57) ABSTRACT

The invention provides a database file management system for managing files with various types by linking files stored in a computer into a database, the files being provided with characteristic fields such as date, title, description, classification, and property. A user defines and integrates various types of electronic files such as visual, audio, and text files according to his/her perception. The database file management system allows the user to specify related parameters in a database according to user preference. The database file management system automatically integrates files based on the parameters specified by the user such that an output data set is derived. Taking into consideration that most of file management systems are subject to restriction of folders and thus any files contained in different folders do not link to each other, the database file management system of the invention allows the user to search for files on a database platform based on the parameters specified by the user.

### BACKGROUND OF THE INVENTION

1. Field of the Invention

A database file management system and a method therefor are provided for the invention, in which a single or a batch of source electronic files associated with an event is linked to a database and is given date, title, description, classification, and properties as a basis for filtering and integrating the files later on. The user may access the source files via the database such that the files are extracted or searched to form pages having specific meanings to the user, thereby readily creating and aggregating new pages that are specifically meaningful to the user. The invention may be used to execute various types of files across folders on a database platform. The files thus are configured as user-specific data sets and the sorting of files is not subject to the restriction that the files must be located in the same folder. The various types of files that can be processed by the system and method of the invention may, for example, include the following formats:

Image file formats: .BMP .DIB .ICO .CUR .WMF .EMF .JPG .JPEG .GIF and the like.

Animation formats and multimedia files with sound and image: .MP3 .WAV .WMA .WMV .ASX .GIF .MPG .MPEG .ASF .SWF and the like.

Executable program formats: .EXE .BAT and the like and linkable Internet address hypertext.

Microsoft Office® file formats: .DOC .XLS .PPT .PPS and the like.

Other filename extensions: .TXT .PDF .HTML .HTM .EML and the like.

2. Description of the Related Art

In general, data are stored as files in a computer system. The electronic files of different types are generated from different sources. For example, videos are generated from video cameras, digital pictures from digital cameras, music from MP3 players, text from Microsoft Word®, worksheets from Microsoft Excel®, and the like. These different types of electronic files are usually indicative of the file formats and also the original sources generating the files by the filename extensions thereof. The nature of different types of electronic files varies significantly; some files can be edited, while others can only be played. Thus, it requires various execution programs to run various types of files. Consequently, file management is difficult when a user faces a large amount of files with different types and their corresponding execution programs.

Traditionally, a user manages files by using folders in a tree-like hierarchy to simulate the structure of file storage. The hierarchy of the folders can sometimes have up to ten or more levels, and may be viewed by expanding the hierarchy level-by-level using file management software such as “file explorer”. Theoretically, a required file in the hierarchy can be located by clicking through the hierarchy, however such searching is often time-consuming and inefficient. Besides, the user may tend to use a very long filename to name the file/folder whereby hoping to identify the content of the file/folder in order to expedite future search. Nevertheless, how can long filenames be used to distinguish with each others when in this age of information explosion and the file/folder contents can be quite similar? Furthermore, it would be very difficult to locate a file as required if the file has contents with multiple meanings and features.

As discussed above, an user, subject to the restriction that electronic files are generated from different sources and run by different execution programs, may often arrange files generated from the same source in a same folder, thus causing cross reference among files with different types more difficult. How may a user get hold of a complete picture of an event when the event is associated with many files of different types? How can a large amount of folders be managed under the situation that new folders are continuously created by a user? Imagine that a user had discovered hundreds of folders upon starting up a computer and hundreds of files upon entering the folders. It would not be easy to promptly locate a particular file if the user did not precisely know the location and filename of the file.

Currently some software can provide partial solutions to the problems as described above, but under the prerequisite that the user must know the filename. Specifically, after the filename is keyed in, the software search across the folders for the file, though files found from the search may not appear in the desired order. Such search tends to be inefficient since it needs to go through folder by folder to find the data. In addition, it is difficult to search for photos and video. Some software provide file management for photo files, and others for music files. However, such software providing partial solutions are only of limited help to the user. The users actually need a more comprehensive method that grasps the full event (associated with many files with various types) across folders, and processes the files in a desired order and manner on the same platform.

Apart from the problems mentioned above, there are two ways of linking data to form information with specific meaning.
1. Converting printed books into individual electronic books: Most electronic books are electronic catalogues that can be downloaded or be re-produced using specific data by a professional organization. Either kind of electronic books have restricted functions and users cannot update the contents thereof;
2. Setting the collected information as pages, modules, knowledge bases and the like based on professional knowledge: By way of job orientation, audio, image, mp3, photo and text files are attached onto pages one by one via complex links. It is thus impossible to automatically classify the associated files according to the user's needs, or to establish a user-defined structure and automatically generate meaningful information. It is also impossible to maintain the original files and to process various types of files dynamically across folders at the same time.

### SUMMARY

In order to solve the prior art problems as mentioned above, the primary purpose of the invention is to provide a method for getting hold of a full account of an event associated with different types of files across folders and for processing the files on a same platform according to an order and manner familiar to the user.

Another purpose of the invention is to provide a method allowing the user to set or designate format for output data sets beforehand as desired, thereby files with various types can be integrated automatically into an output data set from a user-defined database. In other words, the user can readily create a unique new browsing data set or page. For this purpose, the invention also provides a browsing interface, through which the user may browse the set output data sets in a distinctive and rapid manner.

Yet another purpose of the invention is to provide the function of batch or collective processing (which means processing a number of files at once) to improve the operating efficiency of inputting data, which subsequently makes the method applicable in more aspects, such as (1) historical data may be linked into a database as batch-by-batch; (2) repetitive operation (which means the operation of repeating the linking of a batch of files into a database because of the inability to identify which ones are the newly added files within the same data area) automatically eliminates data duplication; (3) properties can be collectively modified; (4) classifications may be collectively modified; and (5) absolute paths and relative paths may be used interchangeably. Thus, the invention can provide certain management capability for operation on offline storage media and among various computers.

For the above purposes, the invention provides a database file management system including a main database and an execution module, wherein the main database satisfies the following conditions: (1) files with various types may be readily managed according to the sequence of the events; (2) five characteristic fields consisting of date, title, description, classification (category and sub-category) and property are provided for the user to define a record; and (3) a first file and a second file may be linked to the record, the first file being a text file and the second file being a file of arbitrary type. On a database platform, the execution module is used to run the application programs associated with the files to browse, play, or edit files across folders.

The aforementioned database file management system further includes a subsidiary database configured to store parameters of output data sets set or designated by the user, so that the output data sets can be displayed in a desired manner. Data sources used to perform setting are relevant fields and files in the main database, the settings including: (1) output settings; (2) filter settings; and (3) display settings.

The database file management system mentioned above may also include a database glossary for storing: (1) user pre-specified codes and names for the classifications and properties, and upon the codes and names are specified, the contents of the classification and property fields for a record can be selected from a pull-down menu including the codes and names specified by the user; and (2) user pre-specified thematic classified data set collections, which after being specified, appears in the main menu for the user to choose conveniently.

Additionally, the invention further provides an integration module for a database file management system, the integration module being configured to integrate the aforementioned database file management systems including the main database, the execution module, and the subsidiary database. The integration module integrates various types of files in the main database defined by the user into a sorted and filtered output data set.

Additionally, the invention further provides a browsing interface for a database file management system, the browsing interface being configured for the aforementioned database file management systems including the main database, the execution module, and the subsidiary database. The browsing interface displays data sets according to the user's categorization and provides a function of fast searching targeted files across folders and file types, and has the following characteristics of: (1) browsing all the data sets set by the user using cover images; (2) classifying data sets into several sections for browsing; (3) each data set having functions of exhibiting the combination of text and graphics and inserting clip arts, without affecting the source files; (4) displaying a large amount of icons in an icon index page for fast searching files as needed; and (5) displaying a large amount of contents icons set by the user in a contents index page for fast searching files as needed.

In addition, the invention further provides a method for database file management to manage files with various types across folders, the method including the following steps of:

(1) entering the main menu; proceeding to step (2) for browsing data sets, to step (4) for inputting data, or to step (13) for ending task;

(2) browsing data sets; proceeding to step (1) for returning to the main menu upon finishing browsing, or to step (3) for setting data sets;

(3) carrying out the following settings before returning to step (2) in order for the output data sets to be displayed as desired: (a) output settings; (b) filter settings; and (c) display settings;

(4) proceeding to step (1) for returning to the main menu, to step (5) for defining a record, to step (6) for adding a multimedia file, to step (7) for adding a text file, to step (8) for inserting/deleting a record, to step (9) for sorting/searching a record; to step (10) for building a database glossary, to step (11) for editing text, or to step (12) for viewing/playing a multimedia file;

(5) creating a new record or searching for an existing record, and filling in the contents of the five characteristic fields consisting of date, title, description, classification, and property of the record, before returning to step (4);

(6) creating a new record or searching for an existing record, selecting a specific multimedia file, and linking it to the record, before returning to step (4);

(7) creating a new record or searching for an existing record, selecting a specific text file or opening a new text file, and linking the text file to the record, before returning to step (4);

(8) inserting a new record or deleting an existing record, before returning to step (4);

(9) sorting/searching the existing records and locating a record as needed, before returning to step (4);

(10) creating two database glossaries as may be needed by the user before returning to step (4), each of the database glossaries storing one of the followings: (a) user pre-specified codes and names for the classifications and properties, and upon the codes and names are specified, the contents of the classification and property fields for a record can be selected from a pull-down menu including the codes and names specified by the user; and (b) user pre-specified thematic classified data set collections, which after being specified, directly appears in the main menu for the user to make the selection conveniently.

(11) locating an existing record, clicking the text file linked to this record, and editing the text file, before returning to step (4);

(12) locating an existing record, clicking the multimedia file linked to this record, and viewing/playing the multimedia file, before returning to step (4);

(13) leaving the main menu to end all tasks.

In summary, the invention provides a database file management system, an integration module and a browsing interface for the database file management system, and a database file management method. The invention provides an event-oriented and object-oriented database management architecture using a plurality of databases to manage files with various types across folders to enable functions of fast editing, playing, and searching.

### BRIEF DESCRIPTION OF THE DRAWINGS

FIG. 1 illustrates a main operating procedure for a database file management system of the invention.

FIG. 2 illustrates an operating procedure for setting data sets in a database file management system of the invention.

FIG. 3 shows a snapshot of an exemplary main menu in an embodiment of the present invention.

FIG. 4 shows a snapshot of inputting data in an embodiment of the present invention.

FIG. 5 shows a snapshot of adding an image/multimedia file in an embodiment of the present invention.

FIG. 6: shows a snapshot of adding an image/multimedia file and selecting for classification and property in an embodiment of the present invention.

FIG. 7 shows a snapshot of adding a text file in an embodiment of the present invention.

FIG. 8 shows a snapshot of defining a record and selecting for classification (including category and sub-category) and properties in an embodiment of the present invention.

FIG. 9 shows a snapshot of selecting properties in an embodiment of the present invention

FIG. 10 shows a snapshot of selecting a category in an embodiment of the present invention.

FIG. 11 shows a snapshot of searching data in an embodiment of the present invention.

FIG. 12 shows a snapshot of creating a database glossary in an embodiment of the present invention.

FIG. 13 shows a snapshot of an exemplary “image browser” in an embodiment of the present invention.

FIG. 14 shows a snapshot of setting data sets by selecting a sorting method for exemplary “output settings” in an embodiment of the present invention.

FIG. 15 shows a snapshot of setting dataset by selecting a page format for exemplary “output settings” in an embodiment of the present invention.

FIG. 16 shows a snapshot of an exemplary “text page” in an embodiment of the present invention.

FIG. 17 shows a snapshot of setting filter criteria in an embodiment of the present invention.

FIG. 18 shows a snapshot of an exemplary “contents index page” in an embodiment of the present invention.

FIG. 19 shows a snapshot of an exemplary “icons index page” in an embodiment of the present invention.

FIG. 20 shows a snapshot of an exemplary thematic classified data set collection containing 16 data sets in an embodiment of the present invention.

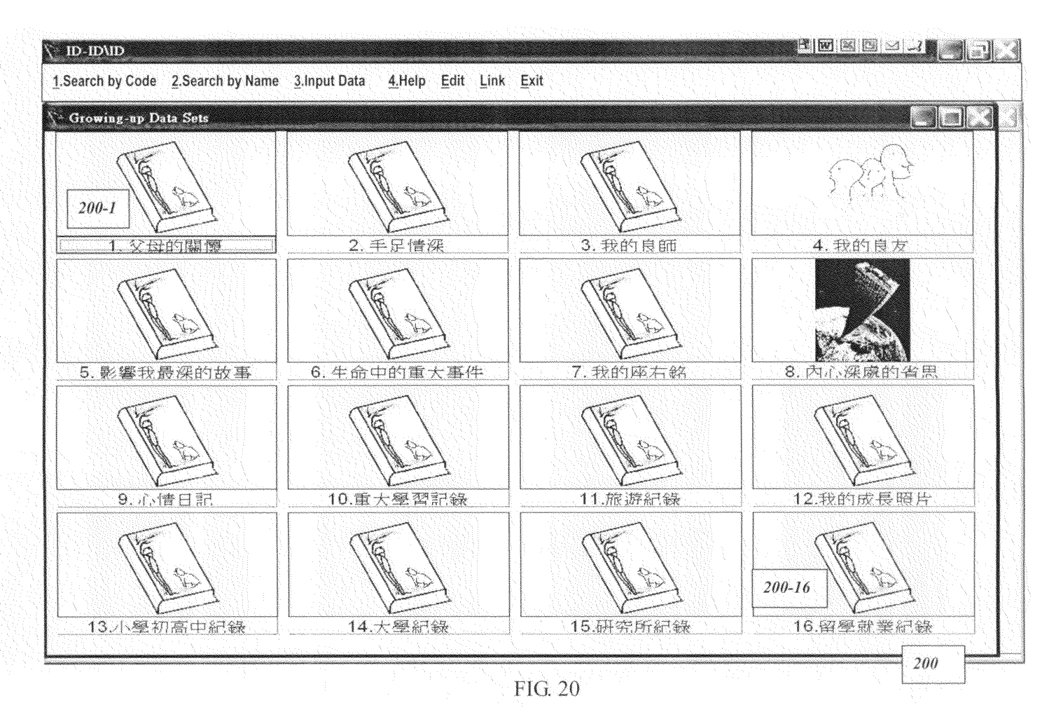

FIG. 21 shows a snapshot of selecting a browsing area in an embodiment of the present invention.

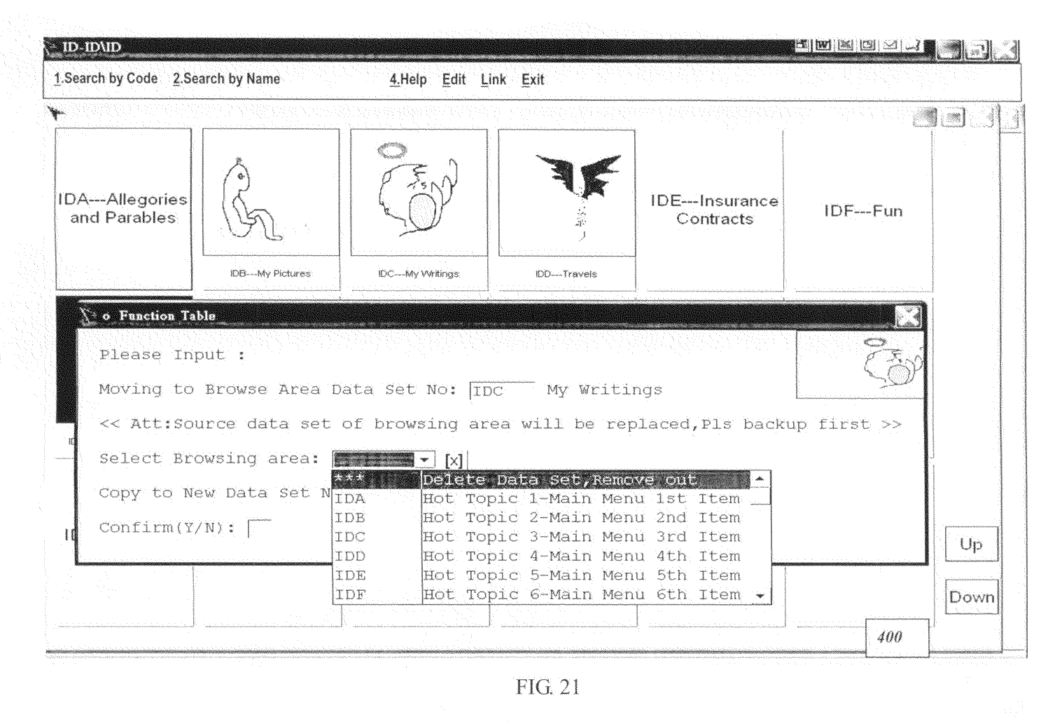

### DETAILED DESCRIPTION OF THE PREFERRED EMBODIMENTS

Preferred embodiments of the invention are described below with reference to the accompanied drawings hereof.

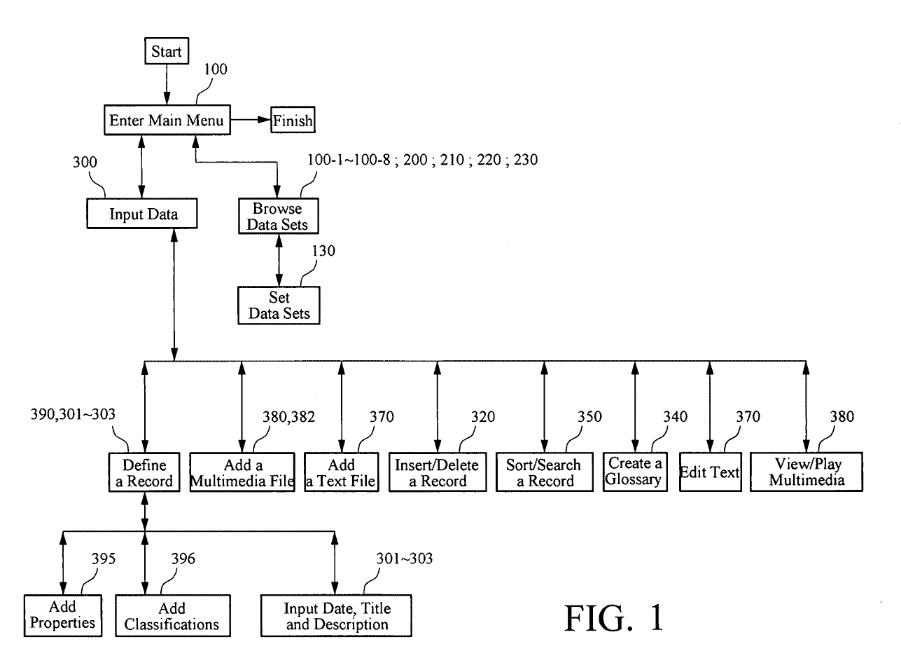

A main operating procedure for a database file management method of the invention is illustrated as in FIG. 1. To begin with, the user enters a main menu (100), and then proceeds to “input data” (300) or “browse data sets” (100-1˜100-8, 200, 210, 220, 230). The user may also leave the main menu to end all tasks.

If “input data” is selected, the following steps may be carried out, including: “define record” (390, 301˜303), “add multimedia file” (380, 382), “add text file” (370), “insert/delete record” (320), “sort/search record” (350), “create database glossary” (340), “edit text file” (370), and “browse/play multimedia file” (380). The user may also return to the main menu.

If “browse data set” is selected, then “set data set” (130) may be carried out. The user may also return to the main menu.

The following is discussed in two parts, “input data” and “browse data set”:

### 1. Input Data

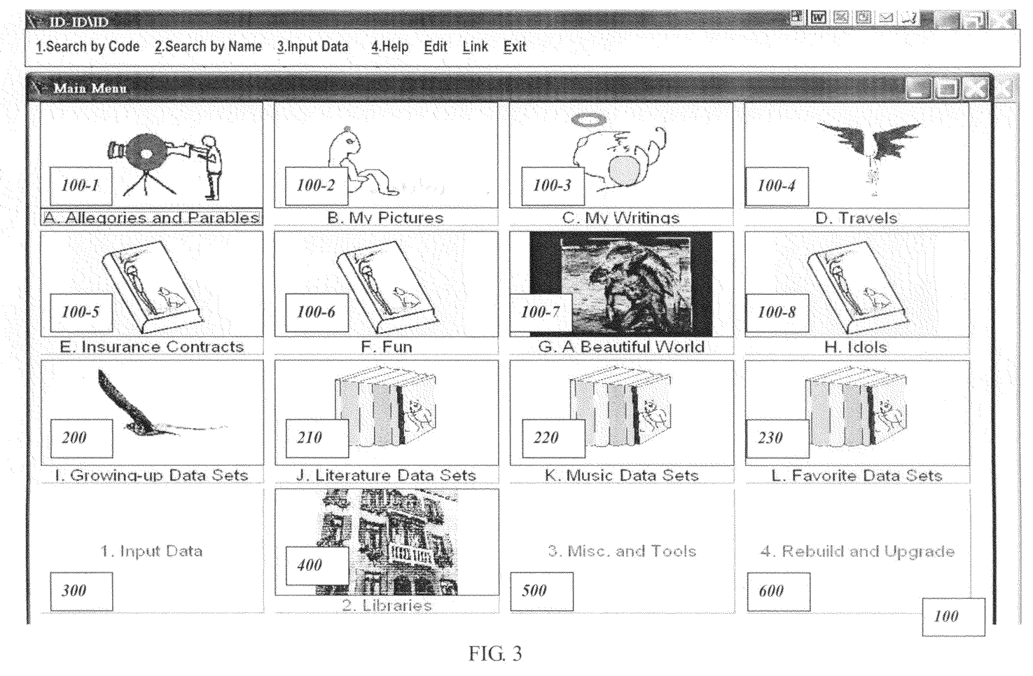

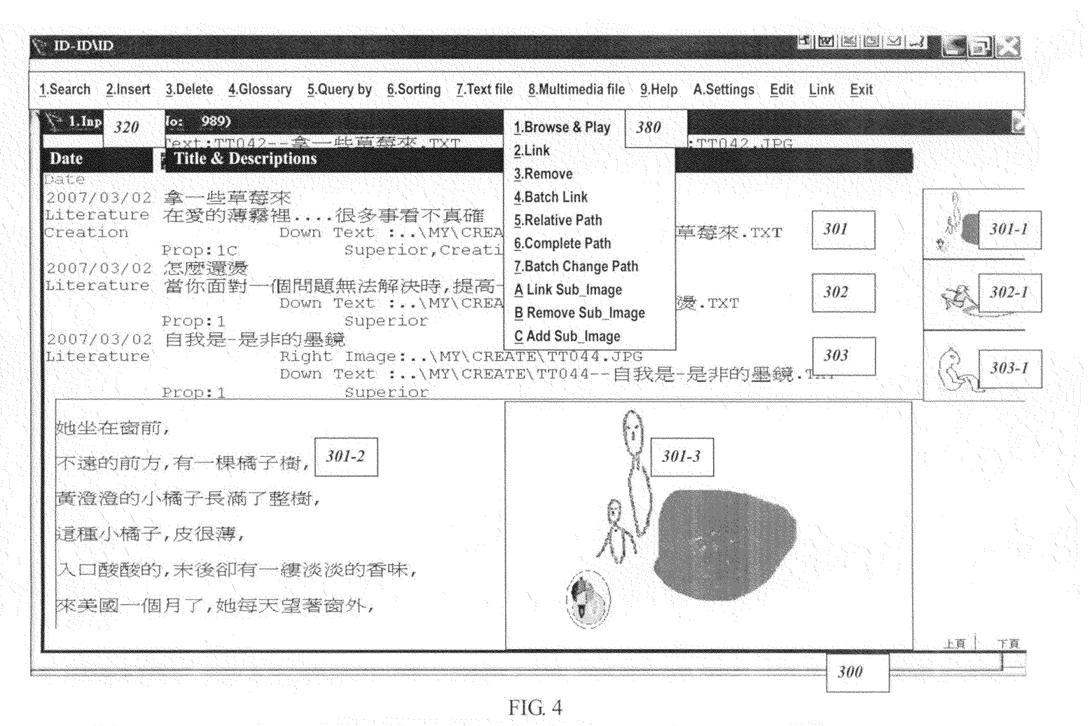

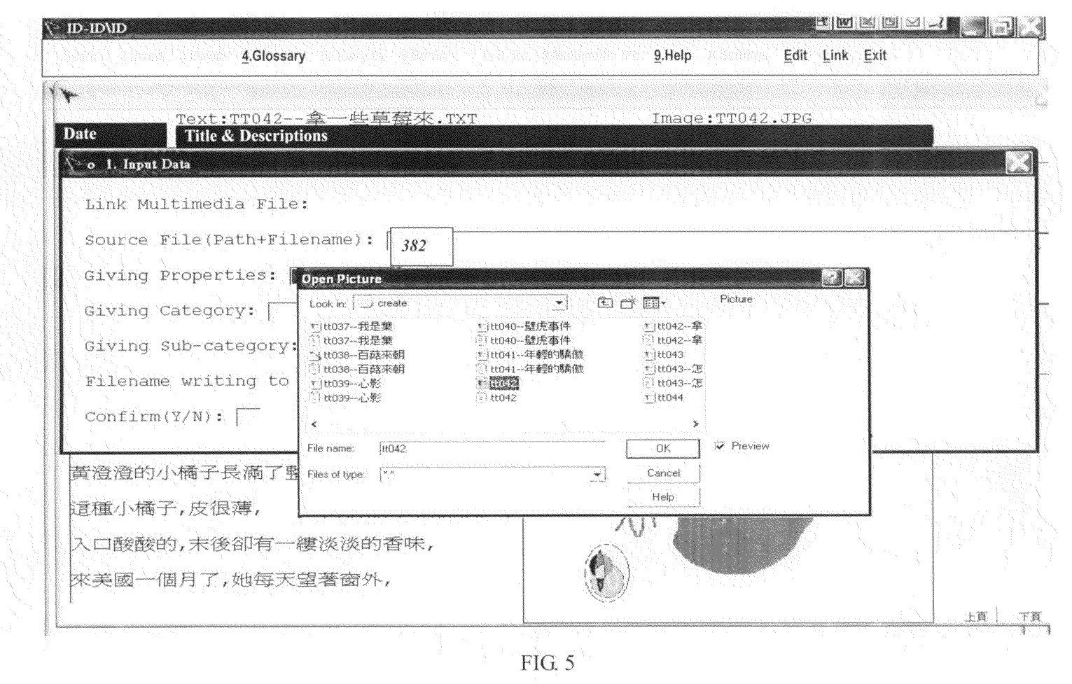

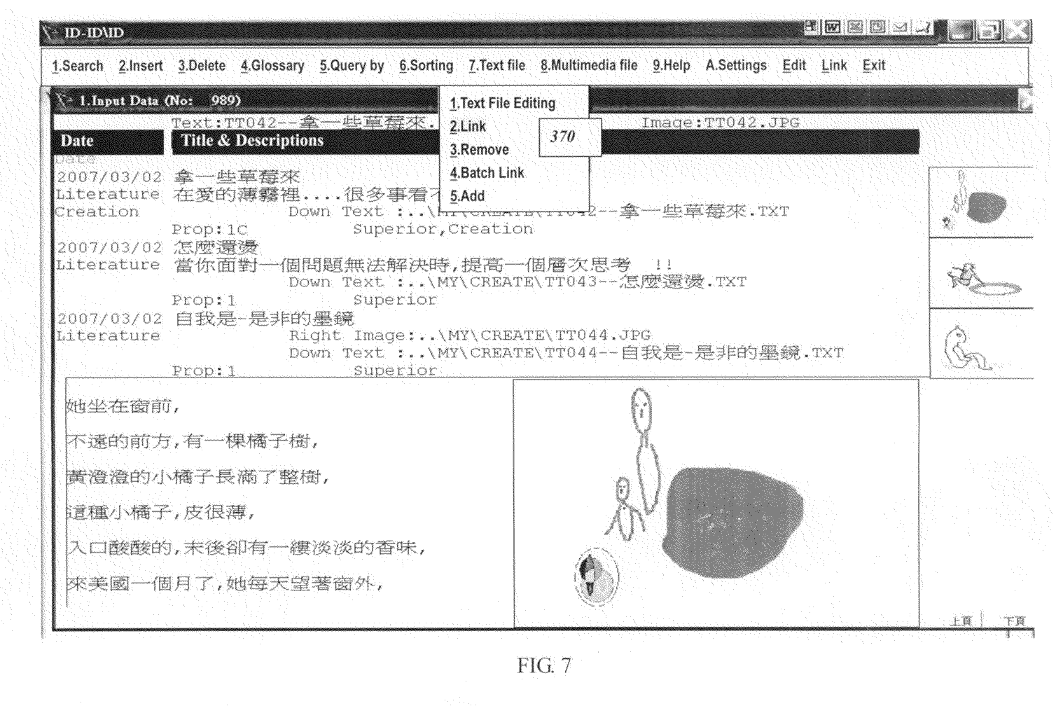

The user starts from the main menu (as in FIG. 3), click 300 to enter “input data” (as in FIG. 4). The snapshot shows three records appearing at once, the one record with the cursor placed on has four display sections, including a data section 301, an image section 301-1, a text section 301-2, and an image zooming section 301-3. When the cursor is moved to 302, the associated text of the record is displayed in the text section while the image is enlarged in the image zooming section. Now the user may add or delete records by selecting the “insert” or “delete” item of 320, and may enter 382 (as in FIG. 5) to select the desired image to be linked to the record by clicking the second item (Link) of 380. Moreover, the user may click 370 (as in FIG. 7) to determine whether an existing text file is linked to the foregoing image, or a new text file is created to be linked to the image, via a procedure similar to that of 382 (as in FIG. 5). Clicking as above, the user has successfully accomplished the association of an image file with a text file.

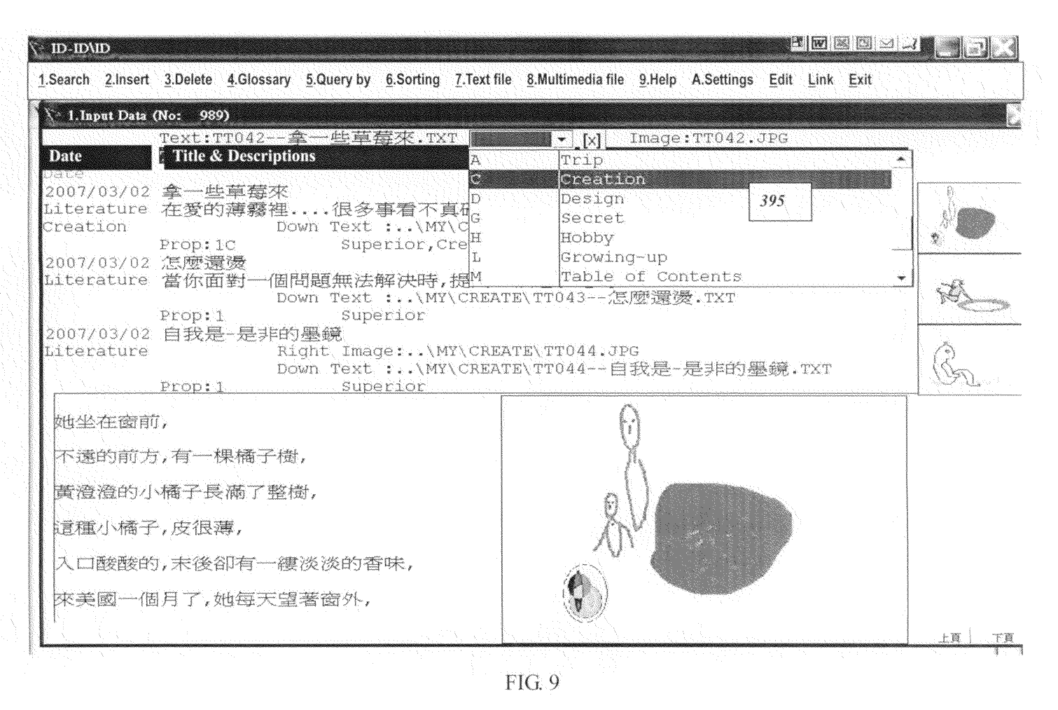

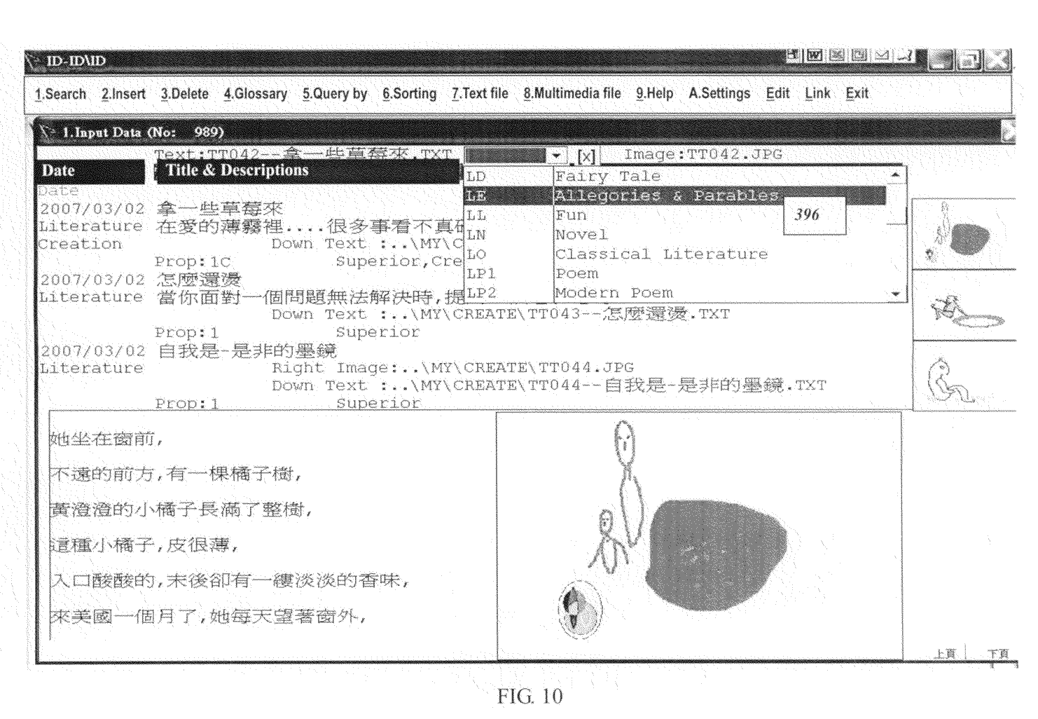

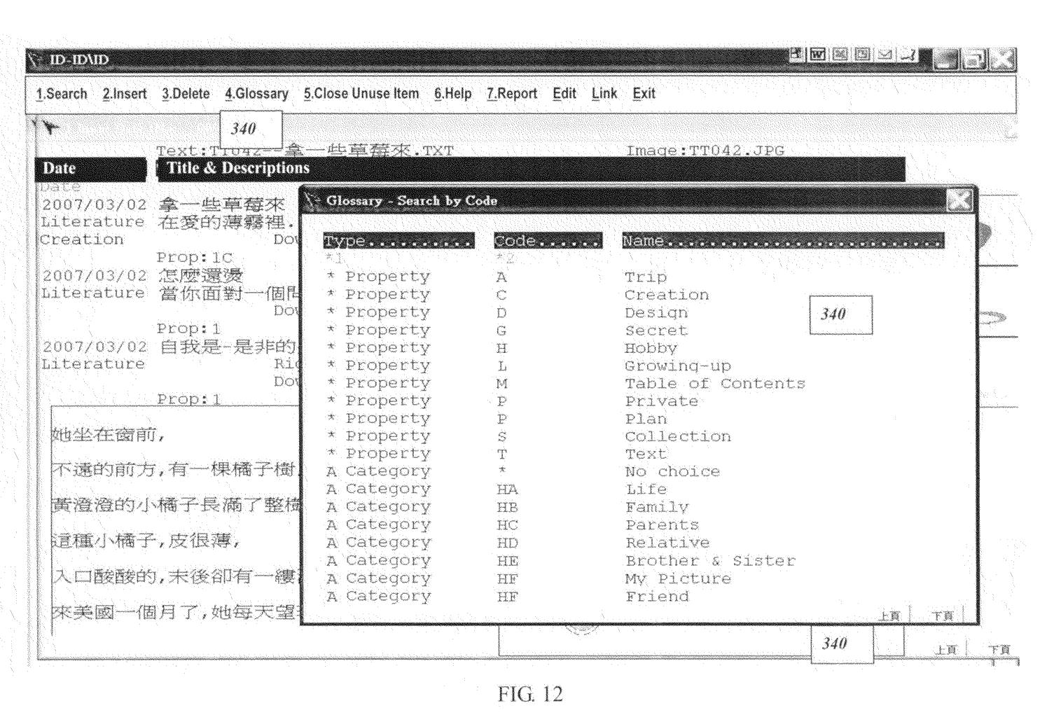

Next, we explain how to “create database glossary”. After entering “input data”, the user may create a database glossary (as in FIG. 12) by clicking 340, at which the followings can be inputted: (1) codes and names for the classifications (including category and sub-category) and properties; and (2) name of the thematic classified data set collection. The classification and property codes may be assigned according to the user's preference. After the user has specified the codes and names for the classifications and properties, the contents of the classification and property fields for a record are selected from a pull-down menu (as 395 in FIGS. 9 and 396 in FIG. 10) including the codes and names specified for the classifications and properties. In addition, after the user has specified a name of the thematic classified data set collection, the name of the thematic classified data set collection directly appears in the main menu such that the user can click it conveniently (this is discussed further in “browse data set” part).

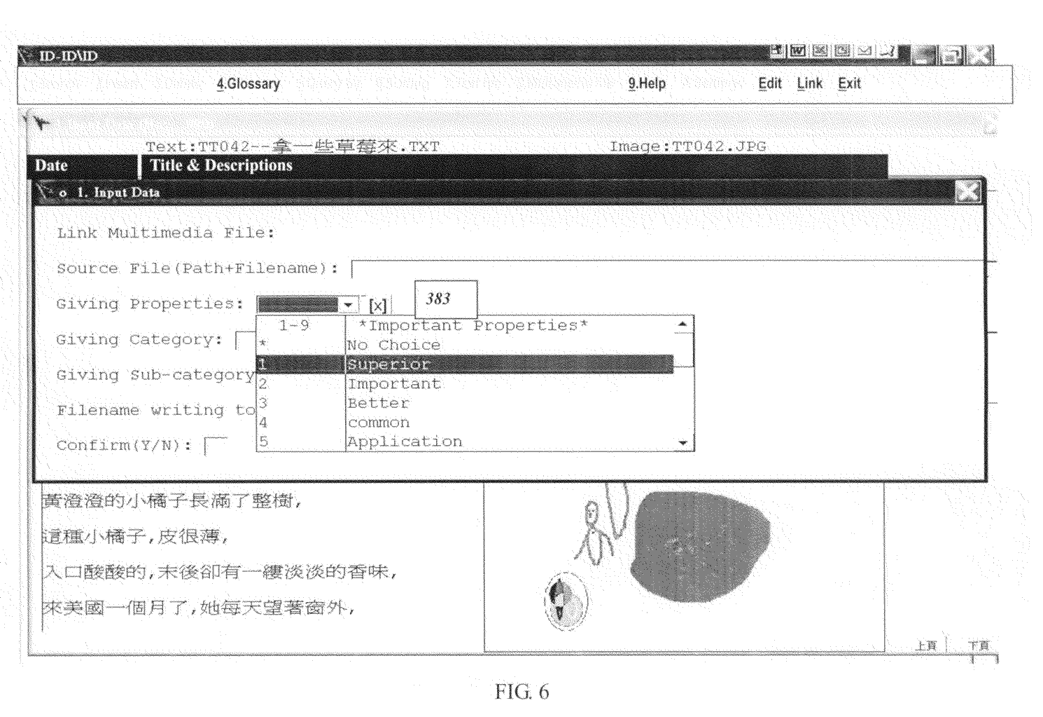

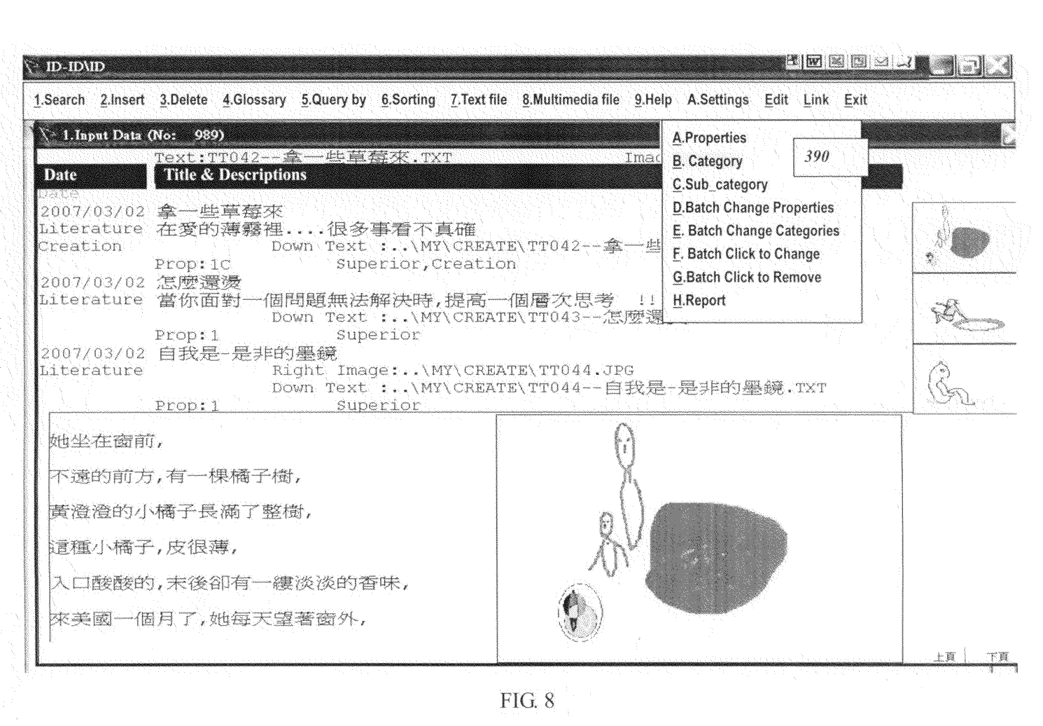

Next, we explain how to “define a record”. The step “define record” refers to giving appropriate contents to the five characteristic fields consisting of date, title, description, classification, and property of a record, wherein the classification and property fields are selected from the pull-down menu including the codes and names pre-specified for the classifications and properties during the “create database glossary” step (as described above), and the date, title and description fields are inputted separately by the user. After a record has been defined, the record is sorted and filtered according to its classification and properties, it is thus very important that the contents of the classification and property fields are adequately given for a record. When the user finds inadequateness in the contents of the classification and property fields previously specified for a record and intends to correct it, the user may proceed conveniently to reselect the classification and property fields of the record by clicking 383 (as in FIG. 6) or 390 (as in FIG. 8).

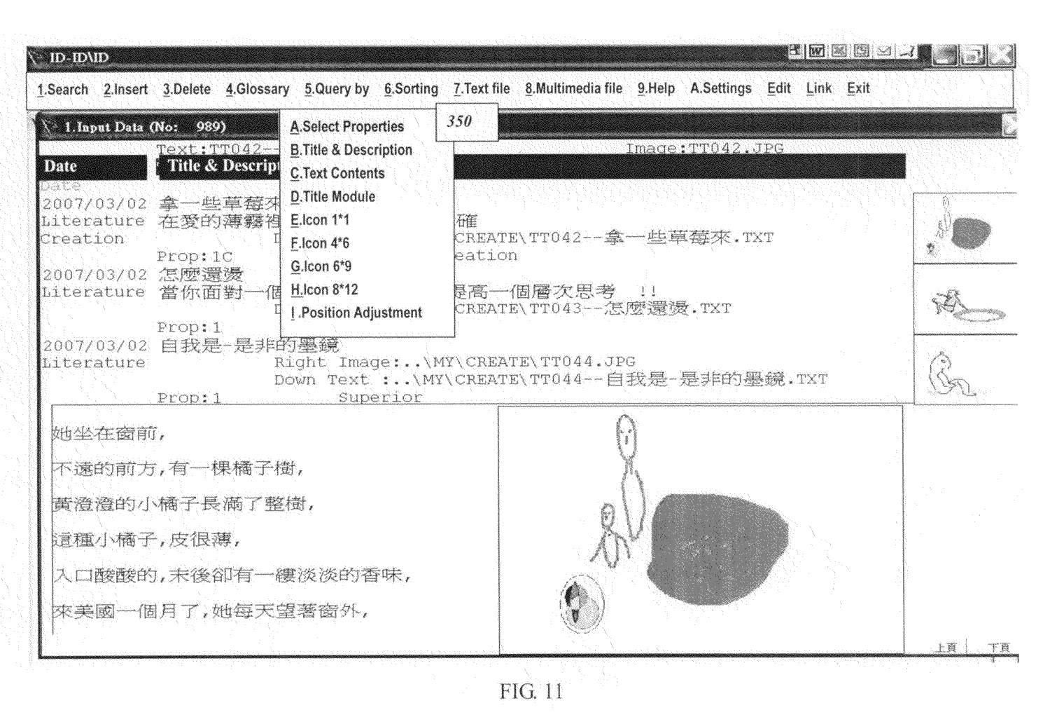

Having proceeded the above steps for a period of time, the user should have accumulated a substantial amount of data. Under the situation, the user needs to quickly locate necessary information while maintaining the data. As shown by 350 in FIG. 11, the sorting order may be selected and specific properties may be chosen (in order to display only the data satisfying or not satisfying the properties so as to filter out a large amount of unnecessary data), and files may also be promptly located by searching specific titles, descriptions or contents. In addition, the targeted files may also be searched using icons, for example, clicking H in 350 may provide the function of browsing 96 icons at once, and records can be quickly moved onto the desired data. The basic functions of the invention include real-time zooming in and out the images for all types of files across folders, playing back multimedia files, or maintaining and editing files with all basic type of Windows® and most of other types of files, on a database platform during maintenance period. For example, by clicking 1 in 380 as shown in FIG. 4, a multimedia file linked to a record with the cursor placed thereon may be opened for viewing its contents; and by clicking 1 in 370 as shown in FIG. 7, a text file linked to a record with the cursor placed thereon may be opened for editing.

So far, the main operation steps of “input data” have been explained. The “browse data set” is then explained in the following sections.

### 2. Browse Data Set

The user may enter from the main menu by clicking 100-1˜100-8 to browse eight data sets. The eight data sets are provided for the user to allocate his/her most favorite data sets. The user may enter “thematic classified data set collection” by clicking one of 200˜230 (referring to the part explaining “create database glossary” in the “input data” section). Each theme includes 16 data sets. In other words, there are 72 data sets on the page provided for the user to click and browse. In addition, the user may also click 400 to enter “my library data set collection” to substitute the aforementioned data sets, and copy the settings of original data sets in the new data set collection. Thus, the user actually owns and maintains an infinite number of data sets.

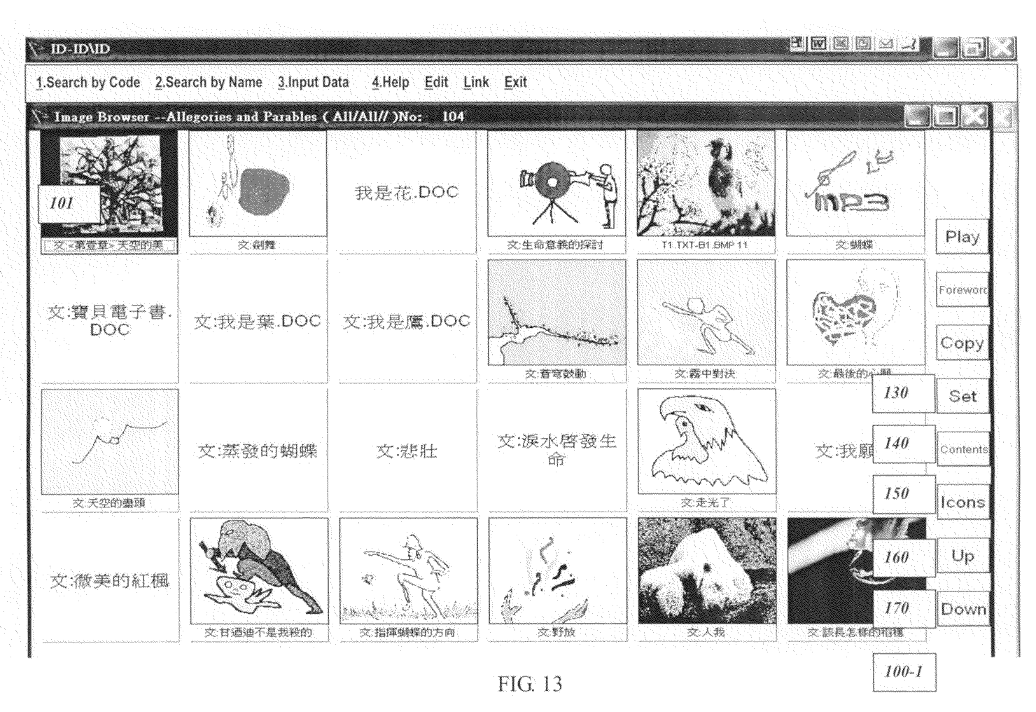

Next, we explain the browsing method. The user clicks one of the data sets, for example, data set 100-1, to enter an “image browser”. As shown in FIG. 13, the exemplary “image browser” has 24 (4 by 6) icons upon entering the browser (the settings may be changed). These icons may represent WORD® or .TXT files, or may show the contents of pictures, presentation, music, or even movies. According to the user preference, a single image browser page may include several files of same type, such as all MP3 music or all .XLS spreadsheets, or files with various types consolidated from various sources. The images shown in the exemplary page indicates that the user has linked the images to some of the records. If the image title, shown as text below the image, is linked to a text file, clicking the text triggers the editing instructions of the source application program of the file. Similarly, clicking the image triggers the editing, playing, or zooming instructions of the source application program of the file. When finishing browsing a single object, the user may return to the “image browser” to continue browsing other objects. Page scrolling-up or scrolling-down may be done by clicking 160 or 170 to display the previous or next 24 icons a time.

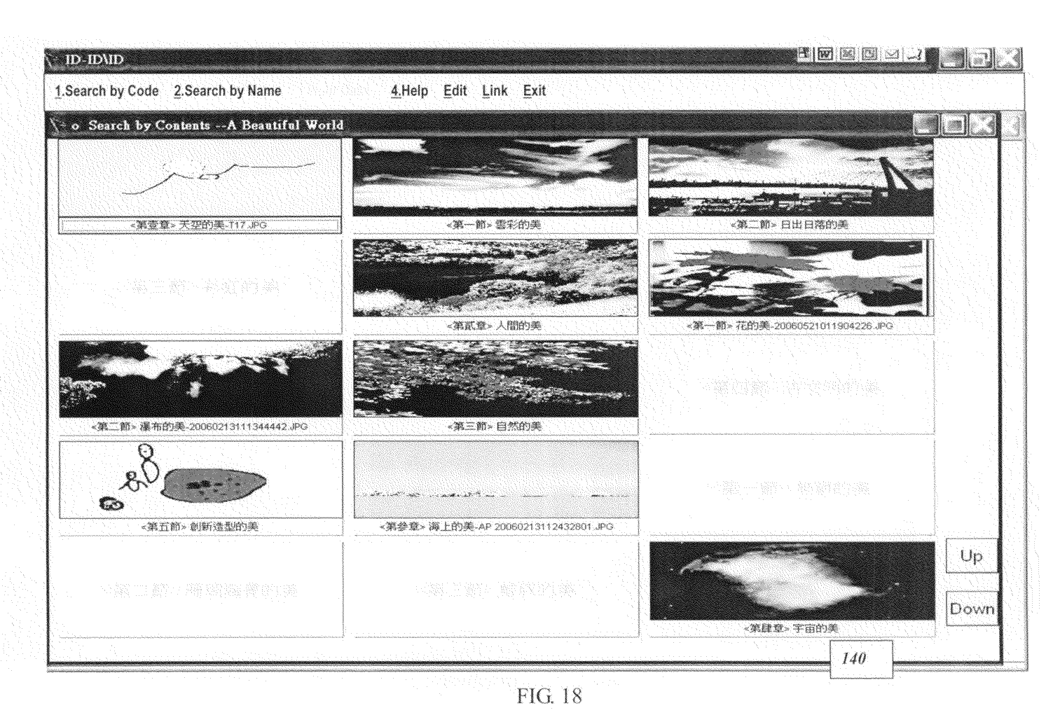

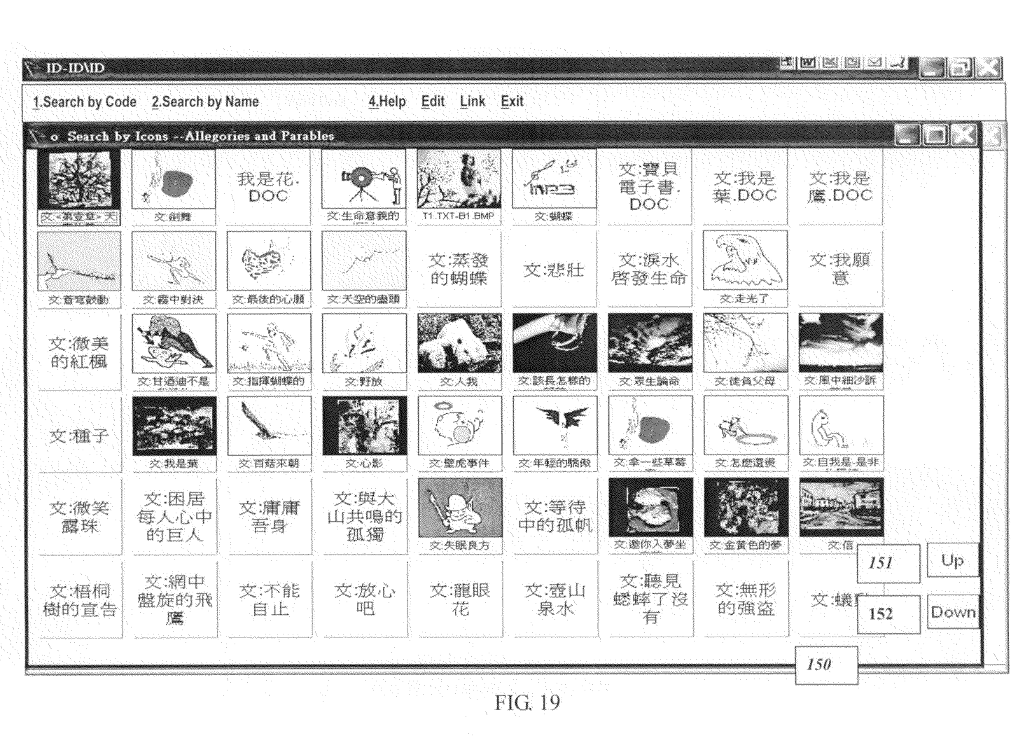

When a single data set accumulates abundant contents covering a large number of data files, the user may have to jump-scroll the pages. The invention provides a function of speed search on the desired records by way of icons 150 and contents icons 140. Button 150 is clicked to enter an icons index page as shown in FIG. 19 and 54 (6 by 9) icons are displayed. Buttons 151 or 152 may be clicked to scroll up or down the page to display the previous or next 54 icons. Once a targeted file is found, the icon of the targeted file may be clicked and then the icon will be displayed at the top left corner of the image browser as shown in FIG. 13. Thus, the browsers or windows are dynamically displayed in a way that the user may continue browsing after performing a search task. In addition, a shown in FIG. 18, button 140 may be clicked to enter a “contents index page”, which has 15 (5 by 3 in this case, the setting can be changed) contents icons displayed on the screen, so the user may quickly move the record to the desired contents icon by clicking one of the icons.

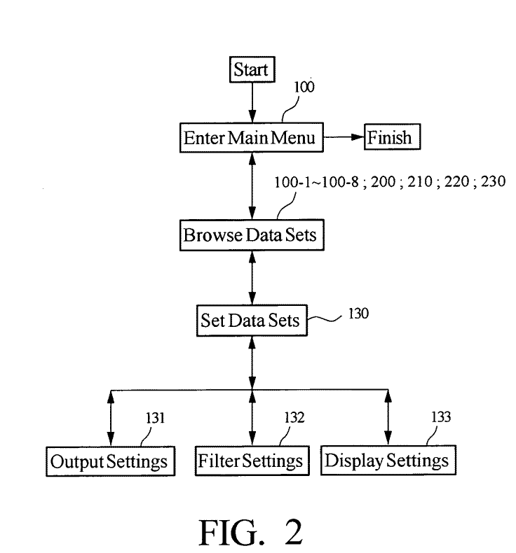

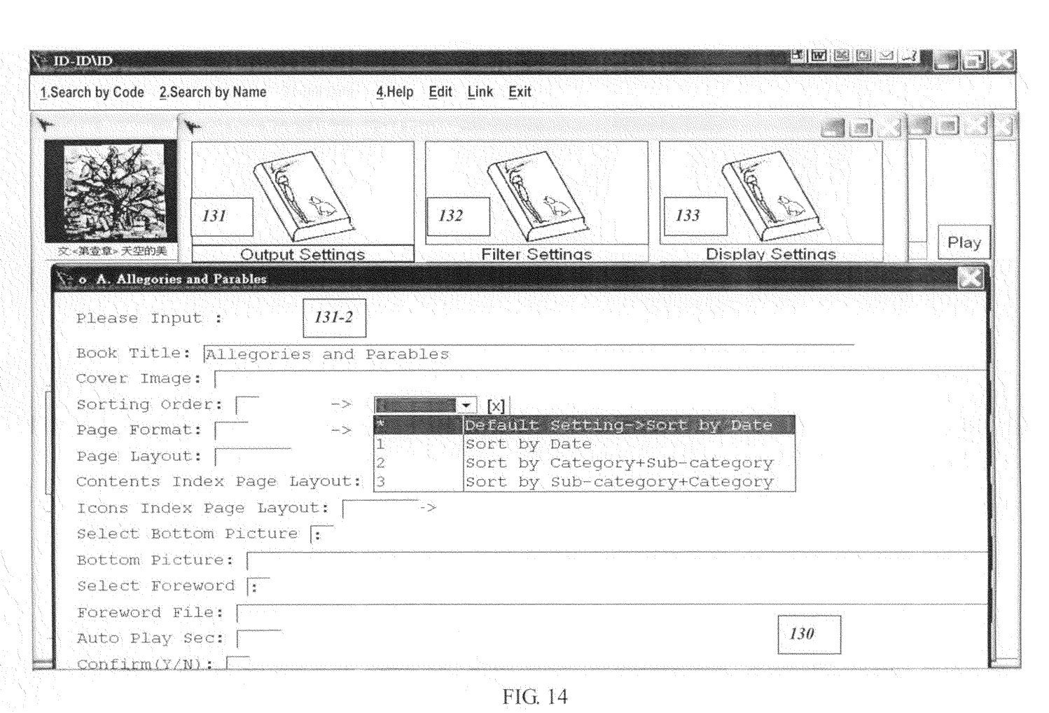

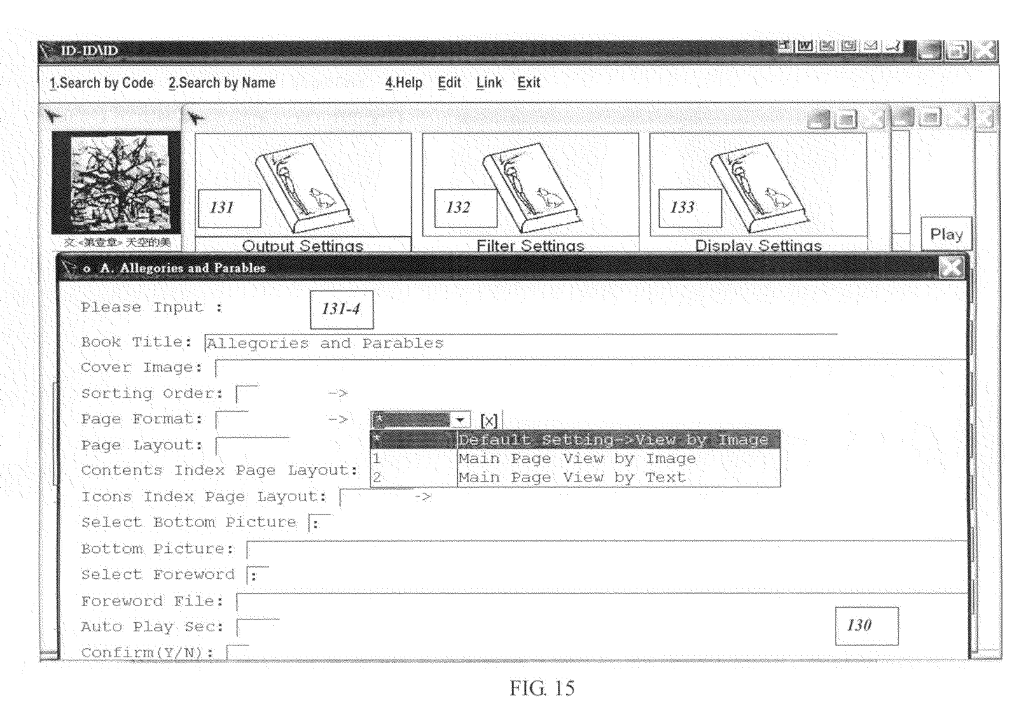

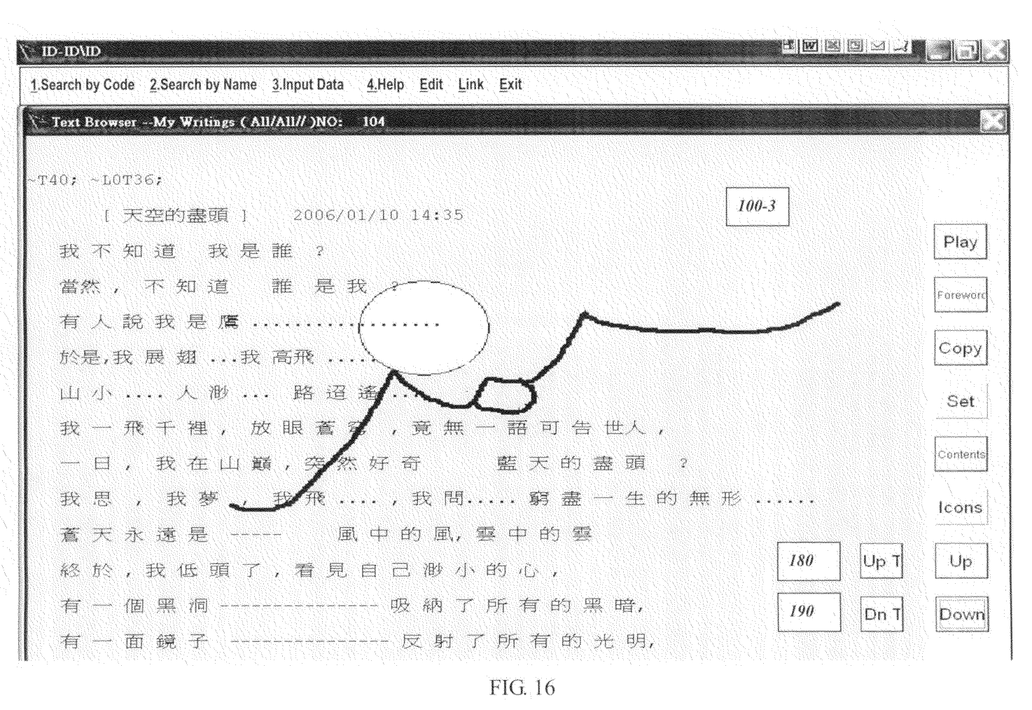

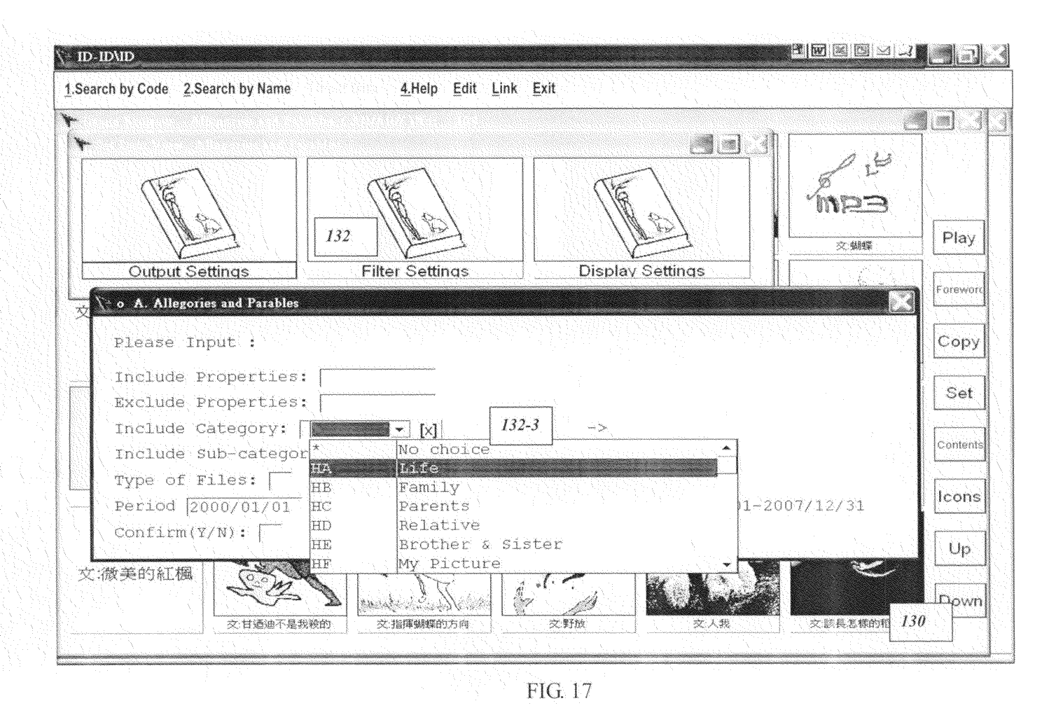

Next, we explain how to “set data set”. After clicking 100-1, the user may enter the “image browser” to browse data sets, as shown in FIG. 13. Then, “set data set” 130 may be clicked to enter the snapshot shown in FIG. 14. Here, the following settings may be performed: “setting output main function” 131, “setting filtering criteria” 132, “setting display mode” 133 (also referring to FIG. 2). As for 131, book title, cover image, sorting order, page format, page layout, contents index page layout, icons index page layout, and the like may be set. It is very important that the setting of sorting order determines the order of the data displayed by the data sets as by: (1) occurring time of events; or (2) category. In addition, as shown in FIG. 15, the main function may be set to display a single text file at a time by setting “page format” so that the system displays a single text file in a maximized window when the user enters to browse data sets. As shown in FIG. 16, if the file being displayed is linked to an image too, the image may be displayed together with the text, either as transparent or other ways. Furthermore, as shown in FIG. 17, setting of 132 determines the contents and characteristics of the data sets by settings of “including properties”, “excluding properties”, “including category”, “including sub-category”, “type of files”, “period” and the like. The setting of 133 includes font size, font type, transparency, page, background and other page formatting settings. Thus the data sets may be displayed as desired by the user who has completed the above settings.

We give some other examples herein. As a first example, the user may define a “category code” for all insurance records, and set an output data set named “my insurance contracts” for the category code. In this way, the user may obtain a “my insurance contracts” data set which includes a variety of insurance files like text, pictures or scanned files, regardless where these files are physically located. As a second example, the invention may be used to keep a growth record of children and properties, such as “important” or “trivial”, or “private” or “public” may be defined to compile the data set into an “important-private” or “trivial-public” version of the “Growing-up” data set. As a third example, music and scores may be included in a data set to create a “wondrous music collection” data set for user to listen to the music while following the sheet music. Similarly, a data set named “my creation” that combines text and pictures may be created easily in such way.

To summarize, the method of the invention is provided for defining original source files for a given event, and concurrently maintaining a variety of information that has “unique and mutually exclusive themes”. The user may give key definitions for events that are closest to the user's perception of the events to obtain an integrated data set collection in real time. The updating of data sets is done in real time, and relevant files remain physically separate while being integrated fully. The files types cover music, audio, animation, presentation and the like. Therefore, the resulting output data sets highly surpass the traditional electronic books.

The method provided by the invention may expand in a flexible fashion in many aspects. For example, the followings are included in the scope of the invention: an “author” or “department” field may be added; friendly user interface may be added or visual aesthetics of the data sets may be enhanced; pages of data sets may be added; the number of icons displayed on a page may be varied; the number of filtering criteria may be increased, and the like. For the purpose, all of the contents of the specification described above are covered within the scope of the accompanied claims of the invention.

What is claimed is:

1. A database file management system for managing files with various types across folders, the database file management system comprising:
a main database satisfying the following conditions: (1) files with various types being real-time managed according to the occurring order of events; (2) five characteristic fields consisting of date, title, description, classification and property being provided for a user to define a record and; (3) a first file and a second file being linked to each record, the first file being a text file and the second file being a file with any type; and
an execution module used to run the application programs associated with the files on a database platform to browse, play or edit the files across folders.

2. The system of claim 1, further comprising a subsidiary database for storing parameters of output data sets set by a user such that the output data sets are displayed as desired by the user, sources of the settings being the relevant fields and files in the main database with the settings including:
(1) output settings;
(2) filter settings; and
(3) display settings.

3. The system of claim 2, wherein the output settings include settings for book title, cover image, sorting order, page format, page layout, contents index page layout, and icons index page layout; the filter settings include settings of including properties, excluding properties, including category, including sub-category, type of files and period; and the display settings include settings of font size, font type, transparency, page, and background.

4. The system of claim 1, wherein the classification field of the main database includes a category field and a sub-category field.

5. The system of claim 1, characterized in that a batch of files can be linked collectively to the main database.

6. The system of claim 1, characterized in that the file storage paths for a batch of files can be updated collectively as absolute or relative paths.

7. The system of claim 1, further comprising a database glossary for storing: (1) user pre-specified codes and names for the classifications and properties, and upon the codes and names are specified, the contents of the classification and property fields for a record can be selected from a pull-down menu including the codes and names specified by the user; and (2) user pre-specified thematic classified data set collections, which after being specified, appears in the main menu for the user to choose conveniently.

8. The system of claim 1, characterized in that the classification and property fields of batched files can be updated collectively.

9. The system of claim 1, characterized in that it allows a user to simultaneously browse a plurality of data, text, images, visual or audio files within a window.

10. The system of claim 1, characterized in that it allows a user to sort data by date or by classification across folders.

11. The system of claim 1, characterized in that it allows a user to search for a targeted file using icons and promptly move a record to a desired data.

12. The system of claim 1, characterized in that it allows a user to filter data according to the included and/or excluded properties of the data.

13. The system of claim 1, characterized in that it allows a user to search a file by promptly searching a record based on title, description or content of the file linked.

14. An integration module of a database file management system configured to integrate the database file management system of claim 2, the integration module integrating the files with various types into an orderly filtered output data set in the main database defined by the user.

15. A browsing interface of a database file management system configured to be used in the database file management of claim 2, the browsing interface displaying data sets according to the user's categorization and providing a function of fast searching targeted files across folders and file types, and having the characteristics of:
(1) browsing all the data sets set by the user using cover images;
(2) classifying data sets into several sections for browsing;
(3) each data set having functions of exhibiting the combination of text and graphics and inserting clip arts, without affecting the source files;
(4) displaying a large amount of icons in an icons index page for fast searching files as needed; and
(5) displaying a large amount of contents icons set by the user in a contents index page for fast searching files as needed.

16. A database file management method for managing files with various types across folders, the database file management method including the steps of:
(1) entering the main menu; proceeding to step (2) for browsing data sets, to step (4) for inputting data, or to step (13) for ending task;
(2) browsing data sets; proceeding to step (1) for returning to the main menu upon finishing browsing, or to step (3) for setting data sets;
(3) carrying out the following settings before returning to step (2) in order for the output data sets to be displayed as desired: (a) output settings; (b) filter settings; and (c) display settings;
(4) proceeding to step (1) for returning to the main menu, to step (5) for defining a record, to step (6) for adding a multimedia file, to step (7) for adding a text file, to step (8) for inserting/deleting a record, to step (9) for sorting/searching a record; to step (10) for building a database glossary, to step (11) for editing text, or to step (12) for viewing/playing a multimedia file;
(5) creating a new record or searching for an existing record, and filling in the contents of the five characteristic fields consisting of date, title, description, classification, and property of the record, before returning to step (4);
(6) creating a new record or searching for an existing record, selecting a specific multimedia file, and linking it to the record, before returning to step (4);
(7) creating a new record or searching for an existing record, selecting a specific text file or opening a new text file, and linking the text file to the record, before returning to step (4);
(8) inserting a new record or deleting an existing record, before returning to step (4);
(9) sorting/searching the existing records and locating a record as needed, before returning to step (4);
(10) creating two database glossaries as may be needed by the user before returning to step (4), each of the database glossaries storing one of the followings: (a) user pre-specified codes and names for the classifications and properties, and upon the codes and names are specified, the contents of the classification and property fields for a record can be selected from a pull-down menu including the codes and names specified by the user; and (b) user pre-specified thematic classified data set collections, which after being specified, directly appears in the main menu for the user to make the selection conveniently;
(11) locating an existing record, clicking the text file linked to the record, and editing the text file, before returning to step (4);
(12) locating an existing record, clicking the multimedia file linked to the record, and viewing/playing the multimedia file, before returning to step (4);
(13) leaving the main menu to end all tasks.

17. The method of claim 16, wherein the step (5): filling in the contents of the five characteristic fields consisting of date, title, description, classification, and property of the record is implemented by:
(a) the contents of the classification and property fields of the record being selected from the pull-down menu including the codes and names specified by the user in step (10);
(b) the contents of the date, title and description fields of the record being given separately by the user.

18. The method of claim 16, wherein the three kinds of settings in step (3) are as follows:
(a) the output settings including settings for book title, cover image, sorting order, page format, page layout, contents index page layout, and icons index page layout;
(b) the filter settings including settings of including properties, excluding properties, including category, including sub-category, type of files and period; and
(c) the display settings including settings of font size, font type, transparency, page, and background.
